(19) United States
(12) Patent Application Publication
(10) Pub. No.: US 2015/0019394 A1
(43) Pub. Date: Jan. 15, 2015

(54) MERCHANT INFORMATION CORRECTION THROUGH TRANSACTION HISTORY OR DETAIL

(71) Applicant: MasterCard International Incorporated, Purchase, NY (US)

(72) Inventors: Kenneth M. UNSER, Fairfield, CT (US); Justin Xavier Howe, Oakdale, NY (US); Po Hu, Norwalk, CT (US)

(21) Appl. No.: 13/939,359

(22) Filed: Jul. 11, 2013

(51) Int. Cl. G06Q 20/00

(52) U.S. Cl. CPC G06Q 20/00
USPC 705/35

(57) ABSTRACT

A method of updating location information associated with a merchant in an electronic payment card network includes retrieving a plurality of payment transaction records associated with a merchant over a predetermined period of time. The plurality of payment transaction records are associated with a plurality of payment accounts, and include location data, including a country of issuance, associated with the payment card accounts. The location data associated with the plurality of payment accounts are aggregated. The merchant's location information is updated in payment transaction records and, optionally, in a central database of merchant location data, based on the aggregated location data associated with the plurality of payment accounts, for example, based on a country of issuance of a majority of the payment cards associated with the payment accounts.

### FIELD OF THE DISCLOSURE

The present disclosure relates to correction of information associated with merchants participating in electronic sales transactions within a payment network, and, more particularly, to a method for correcting merchant information such as location information by analyzing transaction histories or other details for merchants participating in the payment network.

### BACKGROUND

Payment networks receive transaction data from millions of merchants worldwide. Such transaction data, when accurately and consistently linked with the correct merchant information, can be useful for marketing and other purposes. A central database associated with the payment network may be provided for this purpose. Merchant location and identifying information is stored in the database along with detailed payment transaction records associated with each of the various merchants.

In order to maintain the reliability of such data, payment networks need to ensure the accuracy of the merchant information and consistently associate payment transaction records with the proper merchant entity stored in the database. Unfortunately, inaccuracies in merchant information can be captured in transaction records through the normal processes involved in conducting an electronic transaction within a payment network. For example, electronic sales transactions at a merchant point-of-sale are typically forwarded to a merchant bank, or acquiring bank, the bank or financial institution that processes transactions within the payment network for a particular merchant, for authorizing payment. The acquiring bank then populates a payment transaction record with information from the sales transaction for forwarding to an issuing entity of the payment cards, typically a bank, for authorizing and clearing the transaction with the issuing entity.

Occasionally, the acquiring bank for a merchant populates the payment card transaction record with incorrect location or other information. The associated country, state, or metropolitan area information for a merchant may be incorrectly populated for a number of different reasons, such as: the merchant may not have provided the information to the acquirer; a corporate headquarters address may have been provided rather than, for example, the franchisee address; or, in some instances, incorrect country data was included in the transaction record in order to support a multicurrency or dynamic currency conversion setup; or for a variety of other reasons. As a result, the payment card transaction record forwarded to the issuer may contain incorrect merchant information, and thus not be accurately associated with the proper merchant entity that is stored in the central database.

There is a need, therefore, in the art for a method of identifying and correcting inaccuracies in merchant information recorded in a payment card transaction record by an acquiring bank for merchants participating in a payment card network.

### SUMMARY

The present disclosure provides a method and system for identifying and correcting inaccuracies in merchant information recorded in a payment card transaction record by an acquiring bank for merchants participating in a payment card network. Embodiments of the method for correcting such inaccuracies include compiling data from transaction histories or other sources for merchants participating in a payment card network.

A method of updating location information associated with a merchant in an electronic payment network in accordance with the present disclosure includes retrieving, by a processing device, a plurality of electronic payment transaction records associated with a merchant over a predetermined period of time. The plurality of electronic payment transaction records are associated with a plurality of payment accounts and include location data associated with the plurality of payment accounts. The method further includes aggregating, by the processing device, the location data associated with the plurality of payment accounts; and updating, by the processing device, a first electronic payment transaction record of the plurality of electronic payment transaction records with location information associated with the merchant based on the aggregated location data associated with the plurality of payment accounts.

In a particular aspect, each of the plurality of electronic payment transaction records associated with the merchant includes a recorded merchant country location. In addition, the aggregated location data associated with the plurality of payment accounts include a country of issuance associated with each of the plurality of payment accounts. The method further includes identifying, by the processing device, a most common country location corresponding to the country of issuance associated with a highest percentage of the plurality of payment accounts; comparing, by the processing device, the most common country location to the recorded merchant country location; and updating, by the processing device, the recorded merchant country location based on the most common country location.

In another aspect, the method further includes identifying, by the processing device, a mismatch between the recorded merchant country location and the most common country location in the comparing step.

In various additional aspects, the method further includes calculating a volume percentage of a number of the plurality of electronic payment transaction records associated with the most common country location, and the identifying a mismatch step further includes identifying an error in the recorded merchant country location in response to the volume percentage associated with the most common country location exceeding a predetermined threshold.

In yet another aspect, the recorded merchant country location can be stored in a merchant database associated with the electronic payment network, the method preferably further including correcting the recorded merchant country location in the merchant database based on the most common country location.

In various other aspects, the updating step includes populating the first electronic payment transaction record with the most common country location.

In another aspect, the updating step includes replacing the recorded merchant country location associated with the first electronic payment transaction record with the most common country location in response to identifying the error in the recorded merchant country location.

In yet another aspect, the method further includes correcting the recorded merchant country location in the plurality of electronic payment transaction records associated with the merchant based on the most common country location.

A method of updating location information associated with a merchant in an electronic payment network also provided in accordance with the present disclosure includes retrieving, by a processing device, a first payment transaction record associated with a payment account and a first merchant, and a plurality of time sequential transaction records associated with the payment account generated over a time period preceding the first payment transaction record. Each of the plurality of time sequential transaction records are associated with a corresponding one of a plurality of merchants engaged in sales transactions with a user of the payment account. In addition, each of the plurality of time sequential transaction records include location information associated with the corresponding merchant. The method also includes aggregating, by the processing device, the location information associated with the plurality of merchants; and updating, by the processing device, recorded location information associated with the first merchant based on the aggregated location information associated with the plurality of merchants engaged in the sales transactions over the time period preceding the first payment transaction record.

In one aspect, the step of retrieving is performed for each of a plurality of payment accounts, the retrieving step preferably further including retrieving each of a plurality of first payment transaction records associated with each of a plurality of payment accounts and the first merchant, and retrieving the plurality of time sequential transaction records associated with each of the plurality of payment accounts within the time period preceding each of the plurality of first payment transaction records. In addition, the aggregating step includes aggregating the location information associated with the plurality of merchants engaged in sales transactions with the plurality of users of the plurality of payment accounts.

In yet another aspect, the method also includes determining a geographical area of residence associated with the payment account associated with the first merchant, and comparing the geographical area of residence to the aggregated location information. In addition, the updating step preferably further includes updating the recorded location information associated with the first merchant to coincide with the aggregated location information in response to the geographical area of residence being calculated to be within a predetermined distance from a centroid determined from the aggregated location information.

The aggregated location information can include at least one of a country, a state, a city, a province, and a metropolitan area associated with the plurality of merchants.

In various additional aspects, the updating step includes updating the recorded merchant information with at least one of the country, the state, the city, the province, and the metropolitan area based on the aggregated location information.

In addition to the above aspects of the present disclosure, additional aspects, objects, features and advantages will be apparent from the embodiments presented in the following description and in connection with the accompanying drawings.

### BRIEF DESCRIPTION OF THE DRAWINGS

FIG. 1 is a schematic illustration of a representative cycle for electronic cashless sales transaction processing.

FIG. 2 is a flow diagram representation of an embodiment of a method of the present disclosure for correction of information associated with merchants participating in electronic sales transactions within a payment network.

FIG. 3 is a flow diagram representation of another embodiment of a method for correction of information associated with merchants participating in electronic sales transactions within the payment network.

FIG. 4 is a schematic representation of an embodiment of a system for implementing various embodiments of the methods of the present disclosure.

### DETAILED DESCRIPTION OF THE EMBODIMENTS

The following sections describe particular embodiments. It should be apparent to those skilled in the art that the described embodiments provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present method and system as defined herein and equivalents thereto.

Throughout the description, where items are described as having, including, or comprising one or more specific components, or where methods are described as having, including, or comprising one or more specific steps, it is contemplated that, additionally, there are items of the present disclosure that consist essentially of, or consist of, the one or more recited components, and that there are methods according to the present disclosure that consist essentially of, or consist of the one or more recited processing steps.

It should also be understood that the order of steps or order for performing certain actions is immaterial, as long as the method remains operable. Moreover, two or more steps or actions may be conducted simultaneously.

While the payment network described herein is described in terms of a “payment card” for simplicity, which can be a physical card such as a credit, debit, or prepaid card, it is understood that the term “payment card” as used herein and issued for use in a payment network for electronic transactions can also refer to, and be embodied in, any cashless payment device, such as contactless RFID-enabled devices including smart cards, NFC-enabled smartphones, electronic mobile wallets, cloud-based payment devices, and the like as known in the art.

The present disclosure is directed to a system and methods for identifying and correcting inaccuracies in merchant information recorded in a payment card transaction record by an acquiring bank for merchants participating in a payment card network.

In various embodiments, aggregated transaction data and/or historical cardholder behaviors are applied to determine the correct country, state, and/or metropolitan area of a merchant that accepts payment card transactions. This information is then used to detect inaccuracies in payment card transactions generated by an acquiring bank and which may eventually be routed to a central database associated with the payment card network.

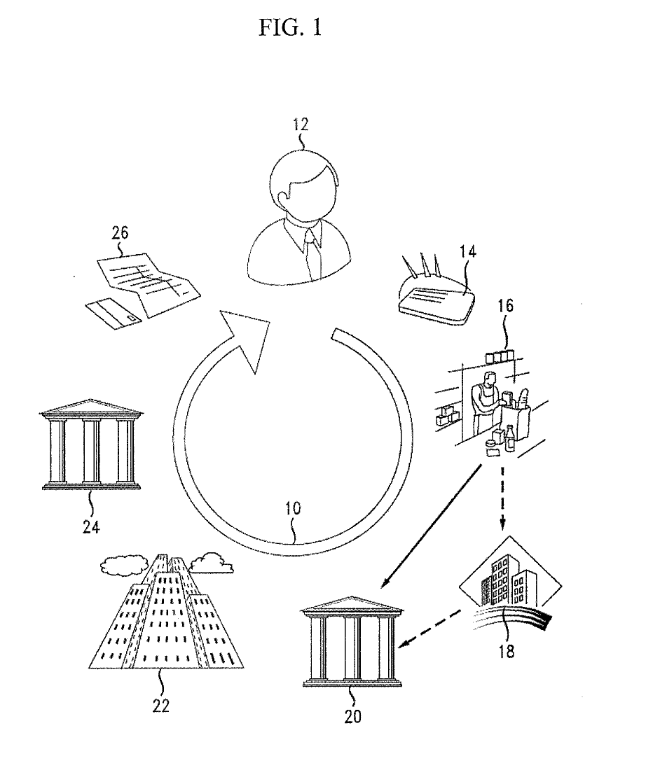

Referring to FIG. 1, by way of example, in a typical electronic sales transaction with a merchant, a device holder 12 presents a payment device 14, for example a payment card, transponder device, NFC-enabled smart phone, among others and without limitation, to a merchant 16 as payment for goods and/or services. For simplicity, the payment device 14 is depicted as a payment card or credit card, although those skilled in the art will appreciate the present disclosure is equally applicable to any cashless payment device, such as contactless RFID-enabled devices including smart cards, NFC-enabled smartphones, electronic mobile wallets and the like.

In cases when the merchant 16 has an established merchant account with an acquiring financial institution (also called the acquirer) 20, the merchant 16 communicates with the acquirer 20 to secure payment on the transaction. An acquirer 20 is a party or entity, typically a financial institution, which is authorized by the network operator 22 to acquire network transactions on behalf of customers of the acquirer 20 (e.g., merchant 16). Occasionally, the merchant 16 does not have an established merchant account with an acquirer 20, but may secure payment on a transaction through a third-party payment provider 18. The third party payment provider 18 does have a merchant account with an acquirer 20, and is further authorized by the acquirer 20 and the network operator 22 to acquire payments on network transactions on behalf of sub-merchants. In this way, the merchant 16 can be authorized and able to accept the payment device 14 from a device holder 12, without having a merchant account with the acquirer 20.

The acquirer 20 typically routes the transaction request from the merchant to a network operating system (also referred to as “network operator”) 22 controlled by the network operations entity (for example, the network system operated by MasterCard International Incorporated, the assignee of the present disclosure). The data included in the transaction request identifies the source of funds for the transaction. With this information, the network operator 22 routes the transaction to an issuer 24, typically a financial institution, which is authorized by the network operator 22 to issue payment devices 14 (payment cards in this example) on behalf of its customers (e.g., device holder 12), for use in payment transactions within the payment network. The issuer 24 also typically funds the transaction that it approves. The issuer 24 may approve or authorize the transaction request based on criteria such as a device holder's credit limit, account balance, or in certain instances more detailed and particularized criteria including transaction amount, merchant classification and so on.

The issuer's 24 decision to authorize or decline the transaction is routed through the network operator 22 and acquirer 20, and ultimately to the merchant 16 at the point of sale. This entire process is carried out by electronic communication, and under routine circumstances (i.e., valid device, adequate funds, etc.) can be completed in a matter of seconds. It permits the merchant 16 to engage in transactions with a device holder 12, and the device holder 12 to partake of the benefits of cashless electronic payment, while the merchant 16 can be assured that payment is secured.

The issuer 24 may then look to its customer, e.g., device holder 12, or other party having financial ownership or responsibility for the account(s) funding the payment device 14, for payment on approved transactions. Generally, a statement or document 26 providing information on the account of a device holder 12, including merchant data is provided by the network operator 22.

A central database is preferably maintained within the payment network for storing and augmenting transaction data, for use in marketing, macroeconomic reporting, and so on. In some cases, transaction data from multiple transactions is preferably aggregated for reporting purposes according to a location of the merchant 16. Of course, one merchant 16 may operate plural card acceptance locations. Consider, for example, a chain or franchise having multiple business locations. It is likewise desirable for different reporting purposes to maintain a merchant identifier for associating and aggregating these different merchant locations with the appropriate merchant identifier. For all purposes, it is necessary and desirable for accurate recording and reporting to consistently and accurately align sales transactions from merchants within the payment network with the correct merchant identifier and location information.

Unfortunately, there is no universal merchant identifier associated with merchant entities. Rather, the network operator 22 must derive information for building the database from the merchant data included in the transaction data delivered via the acquirer 20.

Accordingly, if there is an error or omission in the merchant data included in the sales transaction data sent from the merchant 16 to the acquirer 20, such as errors in the location information, such errors are promulgated to the issuer 24 and network operator 22 and adversely affect the integrity of the central database.

In particular, the acquirer 20 generates payment card transaction records from the sales transaction data provided by the merchant 16 for forwarding to the issuer 24. The acquirer populates the transaction records with payment card and payment card account information, as well as with the merchant information acquired from the sales transaction data transmitted by the merchant 16. For example, the transaction records generated by the acquirer 20 typically include Issuer Identification Number (TIN), also sometimes still referred to as a bank identification number (BIN). The IIN (or BIN), in accordance with industry standards, such as ISO/IEC 7812, contains various types of information. For example, the first digit is the Major Industry Identifier (MII). The MII identifies a type of payment card. For example, a “3” is used for Travel and entertainment, whereas “4” and “5” are used to indicate various banking and financial institutions. As will be appreciated by those of ordinary skill in the art, the IIN number provides information about the card issuer, including the country of issuance.

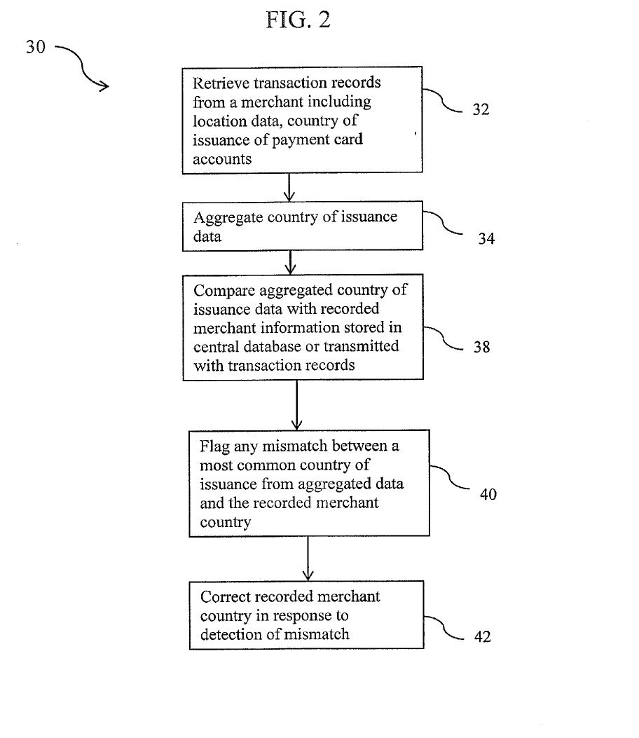

Referring to FIG. 2, in one embodiment 30, a method of updating or correcting location information associated with a merchant in a transaction record generated by an acquiring financial institution includes, at block 32, retrieving a plurality of payment card transaction records associated with the merchant, preferably corresponding to records generated over a predetermined period of time.

The plurality of payment card transaction records are associated with a plurality of payment card accounts, and include location data, such as a country of issuance where each payment card account was issued. This information is readily available, for example, from the TIN codes.

At block 34, the location data from the transaction records is then preferably aggregated to extract location data associated with the plurality of payment card accounts, including a country of issuance associated with each. The location information associated with the merchant, which is often stored in the central database associated with the payment network and is also preferably transmitted in the payment card transaction records from the merchant, can then be examined and compared to the aggregated location data associated with the payment card accounts.

If a large number of the payment cards involved in transactions with the merchant issued outside of the country where the merchant is purportedly located, for example, there is a strong probability that the recorded merchant country location (in the central database and/or in the payment card transaction records) is incorrect. Accordingly, the the acquirer can update the location information in the payment card transaction records associated with the merchant (and merchant location information, if any, recorded in the central database) based on the aggregated location data, such as country of issuance, associated with the payment card accounts engaged in sales transactions with the merchant.

In one embodiment, the payment card transaction records can be sorted by the countries of issuance associated with the payment card accounts. A number of payment card accounts associated with each of the countries of issuance can then be tabulated, and the country of issuance associated with, or being in common with, the largest number, or a largest percentage, of the payment card accounts can be determined (referred to herein as a “most common country location”).

Similarly the number of countries in which payment cards associated with the merchant were issued can be counted. In one embodiment, if all of the payment cards were issued in the same country, and that country differs from the country location of record for the merchant, the recorded merchant country location is more likely an error (than if the payment cards were issued in, for example, thirty different countries) and it is flagged for further investigation and/or correction.

In additional embodiments, a listing of countries of issuance associated with the payment card accounts engaged in sales transactions with a particular merchant can be compiled for consideration of their proximity to a location of record for the merchant. As one of skill in the art will appreciate, if the merchant is listed as being located in Luxembourg, for example, there could certainly be a large number of payment card account holders with accounts established in bordering countries. In this case, the most common country location will not necessarily be a good indicator to determine whether the country location listed for the merchant is correct.

In one embodiment, the most common country location of issuance is then compared to a merchant country location retrieved, for example, from the payment card transaction records retrieved from the merchant. If there is a mismatch between the merchant country code and the most common country of issuance, an error is noted.

In another embodiment, at block 38, the most common country of issuance is compared to a merchant country location stored in the central database associated with the payment network. If there is a mismatch between the merchant country location and the most common country of issuance, it is preferably flagged for further review 40. In certain embodiments, the merchant country location as recorded in the database, or as transmitted in payment card transactions from the merchant, is corrected in response to detecting the mismatch to reflect the most common country of issuance 42.

In additional embodiments, if payment card transaction records are received from the merchant with no merchant country location, the acquiring bank populates the records with the most common country of issuance.

Preferably, a volume percentage of the number of the plurality of payment card transaction records associated with any country of issuance that differs from the recorded merchant country location is calculated. If the volume percentage exceeds a predetermined threshold, an error is flagged in the recorded merchant country location. In certain embodiments, if a volume percentage is calculated for a single, most common country of issuance associated with the plurality of payment card accounts that exceeds a predetermined threshold, the recorded merchant country location in the payment card transaction records, and/or in the central database, are corrected as necessary to consistently reflect the same, most common country location for the merchant transactions.

While comparing countries of issuance of payment cardholders with a recorded country of the merchant engaged in sales transactions is useful for identifying errors in the merchant's recorded country location in many instances, unfortunately, such comparisons require aggregating large data sets. In addition, the correct merchant country cannot be readily identified in cases where the merchant country is small and frequented by cardholders from many other countries (e.g., German, French and Belgian cardholders shopping in Luxembourg). Furthermore, no other card-specific location descriptors associated with the payment cardholder residency (such as cardholder state/zip residency or geographic state of card issuance) are available.

Accordingly, in another embodiment, payment card account activity for a particular user, as reflected in the payment card transaction records transmitted from a merchant, is examined to determine location information associated with the merchant. For example, sequential transactions by a payment cardholder at different merchants can be used to estimate a payment cardholder's country, state, and zip with greater emphasis given to sequential purchases that are closer in time. In this way, the geographic locations of transactions made by the payment cardholder preceding a transaction with a particular merchant can be used to estimate the correct country, state, metropolitan area, and/or zip code of a merchant.

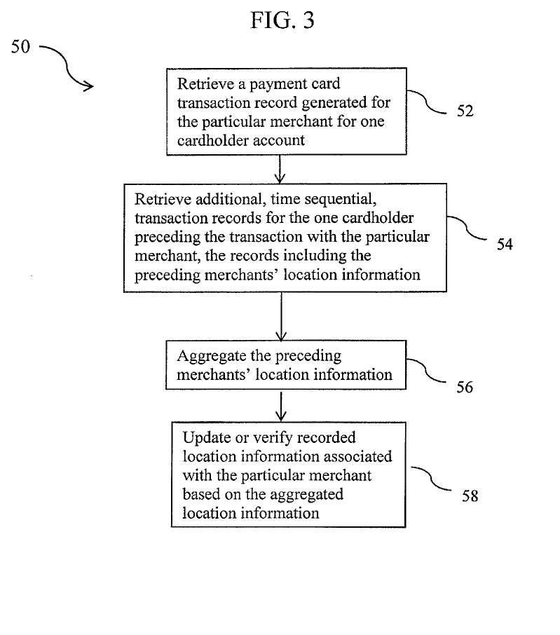

In one embodiment, a method of the present disclosure of updating merchant location information includes retrieving time sequential transaction records generated from one card holder's payment card account to estimate, verify, or correct a particular merchant's location information. Referring to FIG. 3, one method 50 includes retrieving a first payment card transaction record associated with a payment card account and the particular merchant 52. Additional time sequential transaction records associated with the payment card account and generated over a predetermined time period preceding the first payment card transaction record are also retrieved 54. Each of the time sequential transaction records is generated from a sales transaction involving the payment card account and a corresponding merchant, and preferably includes location information associated with the corresponding merchant.

It is understood that the time sequential records associated with the payment card account can, in various embodiments, include transaction records from more than one mode of payment associated with an account holder. As is well understood, the same account holder may have, for example, a virtual card, a plastic credit card, and a NFC-enabled smartphone, all associated with the same account holder. Accordingly, in the methods described herein, it is understood that the time sequential records associated with a payment card account can cut across multiple channels of commerce used by the same account holder.

By way of example, the time sequential transactions could include a transaction by a user with a smartphone followed by an online transaction by the same user or account holder on Amazon.com. In various embodiments, this information can also be used to filter the captured time sequential records for increasing the accuracy of location information. For example, if the smartphone purchase occurred in Manhattan and five minutes later the Amazon transaction originated from Seattle, the Amazon transaction would be filtered out as providing misleading location information.

Referring still to FIG. 3, in one embodiment, the method further includes aggregating the location information associated with a plurality of merchants associated with the preceding time sequential records for the one payment cardholder's account 56.

Finally, recorded location information associated with the particular merchant can be updated, as needed, or verified, based on the aggregated location information associated with the plurality of merchants engaged in the sales transactions with the one card holder preceding the first payment card transaction 58.

In various embodiments, the aggregated location information can include any one or more of a country, a state, a geographic region, or metropolitan area.

Embodiments of the method as described above and represented in FIG. 3 can also include applying the method to a plurality of payment cardholder accounts having transaction records associated with the same particular merchant. In further embodiments, a dominant geographical location can be determined from examining the aggregated location information for the plurality of payment cardholder accounts from the time sequential transaction records preceding the sales transaction(s) with the particular merchant whose location is being verified.

In additional embodiments, the recorded location information for the particular merchant is updated based on the dominant geographical location.

For example, the step of retrieving 52 can be performed for each of a plurality of payment card accounts, so each of a plurality of first payment transaction records associated with each of a plurality of payment card accounts and with the first (or particular) merchant is retrieved. Additionally, the preceding time sequential transaction records (within the time period or interval) are retrieved for each of the payment card accounts preceding each of first payment transactions with the first merchant. Of course, it should be understood that the transactions made by the various payment cardholders at the first merchant do not need to occur in the same period of time relevant to the other payment cardholders. Rather, the relevant period of time is that preceding a particular payment cardholder's transaction at the particular (first) merchant whose location is to be verified.

In this embodiment, the aggregating step preferably includes aggregating the location information associated with the plurality of merchants engaged in the preceding sales transactions for each of the plurality of users of the payment card accounts. The method further includes updating the recorded location information associated with the first merchant based on the aggregated location information, where the aggregated location information now includes data culled from a plurality of payment card holders' transaction histories.

By reviewing the transaction histories of a number of payment cardholders, certain anomalies can be eliminated that could otherwise produce misleading results. For example, if a merchant is located near an area of public transportation, such as near or in airports, train stations, or bus terminals, or in rest areas along interstate highways, examining prior payment cardholder activity will not always be a good indicator of the geographical location of a merchant. In such cases, the preceding transactions of a payment cardholder within the predetermined period of time could easily be in a different state, or country, particularly in certain areas of Europe, and could easily be in a different metropolitan area. Accordingly, updating the particular merchant location based on a payment cardholders' most recent prior transactions with other merchants could easily produce inaccurate results.

To avoid such misleading results, known methods can be applied to estimate a residence of a payment cardholder, for example, based on historical spend data. In particular embodiments, the transactions retrieved from the merchant for each payment cardholder can be filtered to eliminate those cardholders' transactions that occur further than a predetermined distance from the cardholder's residence. For example, in commonly-owned U.S. application Ser. No. 13/721,216, entitled “Method and System for Assigning Spending Behaviors to Geographic Areas,” which was filed on Dec. 20, 2012, by Curtis Villars, a method is provided for estimating a geographic area most frequented by a payment cardholder based on the purchasing history of the payment cardholder. Accordingly, a payment cardholder's travel propensity (or distance from home) can be estimated using the dispersion/variance of their purchases. Those cardholders identified as having a propensity for making purchases at geographically distant merchants, or far from one's estimated residence, would not provide a prior purchase history conducive to establishing a merchant location in the embodiments of the present disclosure.

Accordingly, in a further embodiment, a geographical area of residence of a payment cardholder associated with the payment card account associated with the first merchant is preferably estimated, according to any known method in the art. The geographical area of residence is preferably compared to a centroid determined from the aggregated location information from the preceding transaction records before relying on that data to update the first merchant location information. If the geographical area of residence is within a predetermined distance from the centroid determined from the aggregated location information, the recorded merchant location is updated to coincide with the aggregated location information.

The aggregated location information can include a country, state, city, province, metropolitan, or other defined region. Accordingly, the recorded merchant information can be updated with any one or more of the country, state, city, province, metropolitan, or other defined region determined from the aggregated location information.

### System for Implementing the Methods of the Present Disclosure

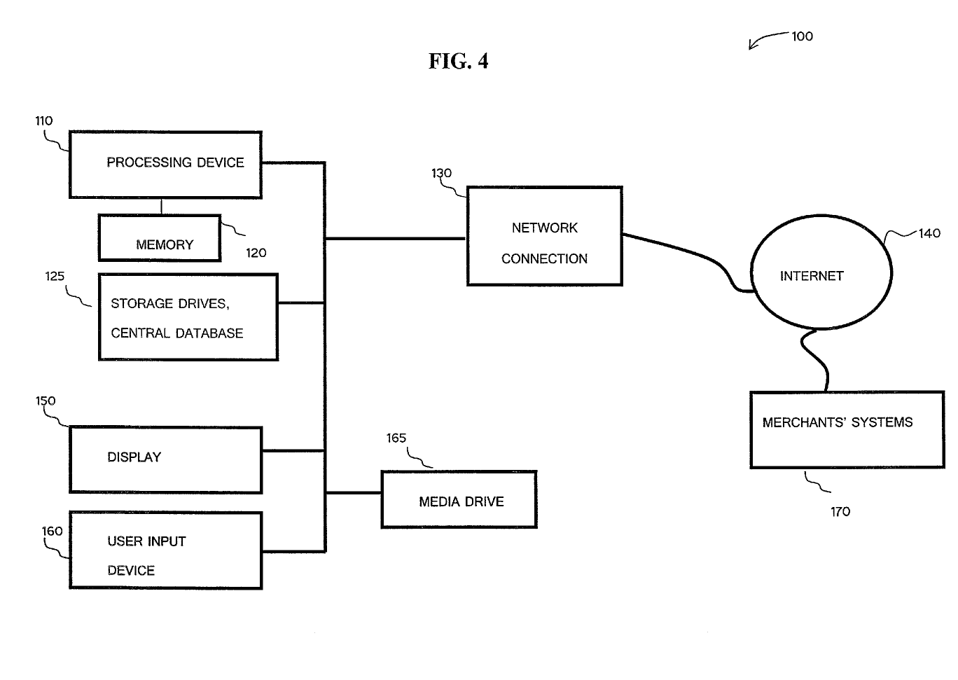

Referring to FIG. 4, the various embodiments of the methods of the present disclosure are implemented via computer software or executable instructions or code. FIG. 4 is a schematic representation of an embodiment of a system 100 for implementing the methods of the present disclosure. The system includes at least a processing device 110 including a Central Processing Unit (CPU), memory 120, storage drives 125 preferably including a central database associated with the payment network, and interface hardware 130 for connecting to merchants' systems 170, via the Internet 140, for example, to retrieve transaction data associated with merchants and for interacting with other systems and components of the payment card network.

The merchant data, including merchant location data and payment record transaction data, are preferably stored in the central database.

Referring still to FIG. 4, the system 100 can be integrated with a computer workstation with display 150 and input keypad or keyboard 160. The memory 120 includes computer readable memory accessible by the CPU for storing instructions that when executed by the CPU 110 causes the processor 110 to implement the steps of the methods described herein. The memory 120 can include random access memory (RAM), read only memory (ROM), a storage device including a hard drive, or a portable, removable computer readable medium, such as a compact disk (CD) or a flash memory, or a combination thereof. The computer executable instructions for implementing the methods of the present invention may be stored in any one type of memory associated with the system 100, or distributed among various types of memory devices provided, and the necessary portions loaded into RAM, for example, upon execution.

In one embodiment, a non-transitory computer readable product is provided, which includes a computer readable medium that can be accessed by the CPU, via a media drive 165, for example, the computer readable medium storing computer executable instructions or program code for performing the method steps described herein. It should be recognized that the components illustrated in FIG. 4 are exemplary only, and that it is contemplated that the methods described herein may be implemented by various combinations of hardware, software, firmware, circuitry, and/or processors and associated memory, for example, as well as other components known to those of ordinary skill in the art.

While the methods and system of the present disclosure have been particularly shown and described with reference to specific embodiments, it should be apparent to those skilled in the art that the foregoing is illustrative only and not limiting, having been presented by way of example only. Various changes in form and detail may be made therein without departing from the spirit and scope of the disclosure. Therefore, numerous other embodiments are contemplated as falling within the scope of the present methods and system as defined by the accompanying claims and equivalents thereto.

What is claimed is:

1. A method of updating location information associated with a merchant in an electronic payment network, the method comprising:
retrieving, by a processing device, a plurality of electronic payment transaction records associated with a merchant over a predetermined period of time, the plurality of electronic payment transaction records being associated with a plurality of payment accounts, the plurality of electronic payment transaction records including location data associated with the plurality of payment accounts;
aggregating, by the processing device, the location data associated with the plurality of payment accounts; and
updating, by the processing device, a first electronic payment transaction record of the plurality of electronic payment transaction records with location information associated with the merchant based on the aggregated location data associated with the plurality of payment accounts.

2. The method of claim 1, wherein each of the plurality of electronic payment transaction records associated with the merchant includes a recorded merchant country location, and wherein the aggregated location data associated with the plurality of payment accounts include a country of issuance associated with each of the plurality of payment accounts, the method further comprising:
identifying, by the processing device, a most common country location corresponding to the country of issuance associated with a highest percentage of the plurality of payment accounts;
comparing, by the processing device, the most common country location to the recorded merchant country location; and
updating, by the processing device, the recorded merchant country location based on the most common country location.

3. The method of claim 2, further comprising identifying, by the processing device, a mismatch between the recorded merchant country location and the most common country location in the comparing step.

4. The method of claim 3, further comprising calculating a volume percentage of a number of the plurality of electronic payment transaction records associated with the most common country location, the identifying a mismatch step further comprising identifying an error in the recorded merchant country location in response to the volume percentage associated with the most common country location exceeding a predetermined threshold.

5. The method of claim 3, wherein the recorded merchant country location is stored in a merchant database associated with the electronic payment network.

6. The method of claim 5, further comprising correcting the recorded merchant country location in the merchant database based on the most common country location.

7. The method of claim 4, wherein the updating step comprises populating the first electronic payment transaction record with the most common country location.

8. The method of claim 4, wherein the updating step comprises replacing the recorded merchant country location associated with the first electronic payment transaction record with the most common country location in response to identifying the error in the recorded merchant country location.

9. The method of claim 4, further comprising correcting the recorded merchant country location in the plurality of electronic payment transaction records associated with the merchant based on the most common country location.

10. The method of claim 1, wherein the location information includes at least one of country location data, state data, and metropolitan area data associated with the merchant, the updating step comprising updating at least one of the country location data, state data, and metropolitan area data based on the aggregated location data.

11. A method of updating location information associated with a merchant in an electronic payment network, the method comprising:
retrieving, by a processing device, a first payment transaction record associated with a payment account and a first merchant, and a plurality of time sequential transaction records associated with the payment account generated over a time period preceding the first payment transaction record, each of the plurality of time sequential transaction records being associated with a corresponding one of a plurality of merchants engaged in sales transactions with a user of the payment account, each of the plurality of time sequential transaction records comprising location information associated with the corresponding merchant;
aggregating, by the processing device, the location information associated with the plurality of merchants; and
updating, by the processing device, recorded location information associated with the first merchant based on the aggregated location information associated with the plurality of merchants engaged in the sales transactions over the time period preceding the first payment transaction record.

12. The method of claim 11, wherein the time period is less than a predetermined period of time.

13. The method of claim 11, wherein the step of retrieving is performed for each of a plurality of payment accounts, the retrieving step further comprising retrieving each of a plurality of first payment transaction records associated with each of a plurality of payment accounts and the first merchant, and retrieving the plurality of time sequential transaction records associated with each of the plurality of payment accounts within the time period preceding each of the plurality of first payment transaction records, the aggregating step including aggregating the location information associated with the plurality of merchants engaged in sales transactions with the plurality of users of the plurality of payment accounts.

14. The method of claim 11, further comprising determining a geographical area of residence associated with the payment account associated with the first merchant, comparing the geographical area of residence to the aggregated location information, the updating step further comprising updating the recorded location information associated with the first merchant to coincide with the aggregated location information in response to the geographical area of residence being calculated to be within a predetermined distance from a centroid determined from the aggregated location information.

15. The method of claim 14, wherein the aggregated location information includes at least one of a country, a state, a city, a province, and a metropolitan area associated with the plurality of merchants.

16. The method of claim 15, wherein the updating step includes updating the recorded merchant information with at least one of the country, the state, the city, the province, and the metropolitan area based on the aggregated location information.
